(19) United States
(12) Patent Application Publication
(10) Pub. No.: US 2023/0124756 A1
(43) Pub. Date: Apr. 20, 2023

(54) MONITORING ITEM MISMATCHES DURING CHECKOUTS IN STORES AND PREVENTING LOSSES DUE TO THE ITEM MISMATCHES

(71) Applicant: International Business Machines Corporation, Armonk, NY (US)

(72) Inventors: Craig M. Trim, Ventura, CA (US); Robert Huntington Grant, Marietta, GA (US); Jeremy R. Fox, Georgetown, TX (US); Fang Lu, Billerica, MA (US); Uri Kartoun, Cambridge, MA (US)

(21) Appl. No.: 17/450,851

(22) Filed: Oct. 14, 2021

(51) Int. Cl. G07G 1/00; G06Q 20/20; G06Q 30/02

(52) U.S. Cl. CPC G07G 1/0072; G07G 1/0063; G06Q 20/208; G06Q 30/0283

(57) ABSTRACT

A computer-implemented method, computer program product, and computer system for preventing losses due to mismatches during checkouts in a store. The computer system causes one or more sensors to capture one or more attributes of an item being checked out by a customer. The computer system matches the captured one or more attributes to one or more attributes corresponding to one of a barcode scanned, a number keyed in, and an item name chosen by the customer. The computer system pauses a checkout process, in response to a mismatch. The computer system calculates a difference between a price corresponding to one of the barcode, the number, and the item name and an actual price of the item. The computer system, in response to determining a significant loss occurring to the store, notifies the store to correct the mismatch and processes a transaction of the item at the actual price.

### BACKGROUND

The present invention relates generally to analyzing data of checkouts in stores, and more particularly to using analysis of data of checkouts to monitor item mismatches during checkouts in stores and prevent losses due to the item mismatches.

Attaching barcode stickers to grocery items, such as individual fruits, deli boxes, and soft drinks, is a commonly used method to associate a price with each item. In many stores, shoppers can scan each item at the time of payment and pay for the entire set of items. In certain situations, an item may not be associated with a barcode, and a shopper needs to type its associated code directly or select an item picture using a terminal of a checkout lane in a store. In a store, a shopper may mistakenly type a wrong code for an item and may result in a significantly low or high price for the item, which may cause a loss to either the store or the shopper.

### SUMMARY

In one aspect, a computer-implemented method for preventing losses due to item mismatches during checkouts in a store is provided. The method includes causing one or more sensors to capture one or more attributes of an item being checked out by a customer. The method further includes matching the one or more attributes captured by the one or more sensors to one or more attributes stored in a database, where the one or more attributes stored in the database is corresponding to one of a barcode scanned by the customer, a number keyed in by the customer, and an item name chosen by the customer. The method further includes, in response to a mismatch, pausing a checkout process of the item. The method further includes calculating a difference between a price corresponding to one of the barcode, the number, and the item name and an actual price of the item. The method further includes, in response to determining a loss occurring to the store, determining whether the difference is greater than a predetermined number of standard deviations of a normal distribution of prices of the item, where the normal distribution is based on historical data of the prices of the item. The method further includes, in response to determining the difference being greater than the predetermined number of standard deviations, notifying the store to correct the mismatch. The method further includes, in response to the mismatch being corrected, processing a transaction of the item at the actual price of the item.

In another aspect, a computer program product for preventing losses due to item mismatches during checkouts in a store is provided. The computer program product comprises a computer readable storage medium having program instructions embodied therewith, and the program instructions are executable by one or more processors. The program instructions are executable to: cause one or more sensors to capture one or more attributes of an item being checked out by a customer; match the one or more attributes captured by the one or more sensors to one or more attributes stored in a database, where the one or more attributes stored in the database is corresponding to one of a barcode scanned by the customer, a number keyed in by the customer, and an item name chosen by the customer; in response to a mismatch, pause a checkout process of the item; calculate a difference between a price corresponding to one of the barcode, the number, and the item name and an actual price of the item; in response to determining a loss occurring to the store, determine whether the difference is greater than a predetermined number of standard deviations of a normal distribution of prices of the item, where the normal distribution is based on historical data of the prices of the item; in response to determining the difference being greater than the predetermined number of standard deviations, notify the store to correct the mismatch; and in response to the mismatch being corrected, process a transaction of the item at the actual price of the item.

In yet another aspect, a computer system for preventing losses due to item mismatches during checkouts in a store is provided. The computer system comprises one or more processors, one or more computer readable tangible storage devices, and program instructions stored on at least one of the one or more computer readable tangible storage devices for execution by at least one of the one or more processors. The program instructions are executable to cause one or more sensors to capture one or more attributes of an item being checked out by a customer. The program instructions are further executable to match the one or more attributes captured by the one or more sensors to one or more attributes stored in a database, where the one or more attributes stored in the database is corresponding to one of a barcode scanned by the customer, a number keyed in by the customer, and an item name chosen by the customer. The program instructions are further executable to, in response to a mismatch, pause a checkout process of the item. The program instructions are further executable to calculate a difference between a price corresponding to one of the barcode, the number, and the item name and an actual price of the item. The program instructions are further executable to, in response to determining a loss occurring to the store, determine whether the difference is greater than a predetermined number of standard deviations of a normal distribution of prices of the item, wherein the normal distribution is based on historical data of the prices of the item. The program instructions are further executable to, in response to determining the difference being greater than the predetermined number of standard deviations, notify the store to correct the mismatch. The program instructions are further executable to, in response to the mismatch being corrected, process a transaction of the item at the actual price of the item.

### BRIEF DESCRIPTION OF THE SEVERAL VIEWS OF THE DRAWINGS

FIG. 1 is a systematic diagram illustrating a system for monitoring item mismatches during checkouts and preventing losses due to item mismatches, in accordance with one embodiment of the present invention.

FIG. 2(A) and FIG. 2(B) present a flowchart showing operational steps of monitoring item mismatches during checkouts and preventing losses due to mismatches, in accordance with one embodiment of the present invention.

FIG. 3 is a diagram illustrating components of a computing device or server, in accordance with one embodiment of the present invention.

FIG. 4 depicts a cloud computing environment, in accordance with one embodiment of the present invention.

FIG. 5 depicts abstraction model layers in a cloud computing environment, in accordance with one embodiment of the present invention.

### DETAILED DESCRIPTION

Embodiments of the present invention provide a solution to errors due to item mismatches during checkouts in stores. In embodiments of the present invention, a system monitors item mismatches during checkouts and prevents losses due to the mismatches. In embodiments of the present invention, a system analyzes data of checkouts. The system disclosed in the present invention improves the quality of the data, which can prevent losses, customer dissatisfaction, and overall drop of a store's image.

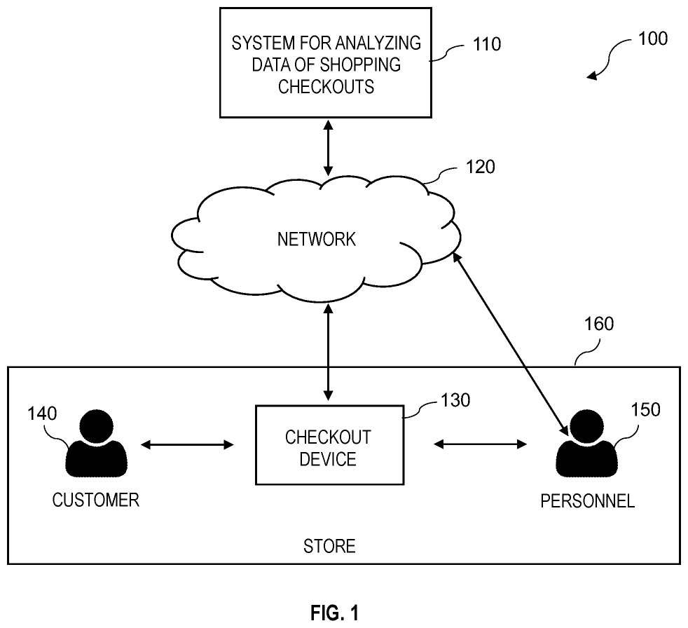

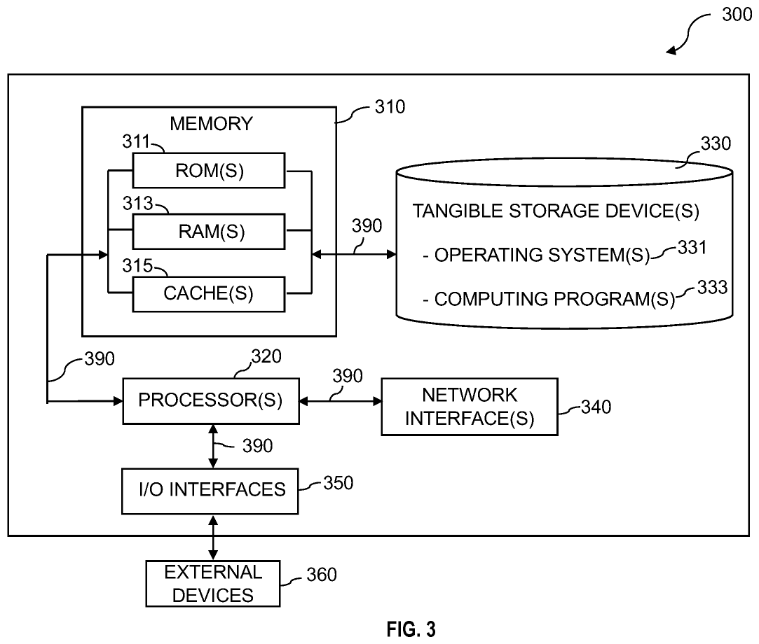

FIG. 1 is a systematic diagram illustrating system 100 for monitoring item mismatches during checkouts and preventing losses due to item mismatches, in accordance with one embodiment of the present invention. System 100 includes system 110 for analyzing data of checkouts. In the embodiment shown in FIG. 1, system 110 for analyzing data of checkouts is situated on a computing device or a server. A computing device or server is described in more detail in later paragraphs with reference to FIG. 3. System 110 for analyzing data of checkouts is connected to checkout device 130 in store 160; the connection between system 110 and checkout device 130 is through network 120.

Network 120 can be any combination of connections and protocols which support communications among the local devices and the central server. For example, the network may be the Internet which represents a worldwide collection of networks and gateways to support communications between devices connected to the Internet; the network may be implemented as an intranet, a local area network (LAN), a wide area network (WAN), and a wireless network.

Checkout device 130 is equipped with a variety of sensors to identify one or more attributes of an item. The sensors may be capable of capturing dimensions (e.g., a sonar to assess height, a scale to assess weight). The sensors may also be capable of capturing other attributes such as temperature and texture. The sensors may be imaging devices, for example cameras, which are capable of capturing images of an item. System 110 causes the sensors to capture one or more attributes of items that are scanned at checkout device 130, during a checkout of customer 140. System 110 may cause one or more imaging devices to capture one or more images. System 110 also causes the sensors to monitor actions of the customer while customer 140 checks out the items.

In one embodiment, system 110 matches the one or more attributes captured by the sensors to the one or more attributes stored in a database, where the one or more attributes stored in the database are corresponding to barcodes scanned by customer 140, numbers keyed in by customer 140, or an item name chosen by customer 140 at checkout device 130. In another embodiment, system 110 matches the one or more images captured by the imaging devices to one or more images stored in a database, where images stored in the database are corresponding to barcodes scanned by customer 140, numbers keyed in by customer 140, or an item name chosen by customer 140 at checkout device 130. In one embodiment, system 110 determines whether there are mismatches between the one or more attributes captured and the one or more attributes stored in the database. In another embodiment, system 110 determines whether there are mismatches between the one or more images captured and the one or more images stored in the database. In response to determining that there is a mismatch of an item, system 110 pauses a transaction of the item; further, system 110 calculates losses due to the mismatch, by calculating a difference between a price corresponding to the barcode, the number, or the item name and an actual price of the item. System 110 retrieves from the database the price corresponding to the barcode, the number, or the item name. The actual price of the item is a price corresponding to the one or more attributes captured by the one or more sensors or the one or more images captured by the one or more imaging devices. System 110 retrieves from the database the actual price.

If the price corresponding to the barcode, the number, or the item name is less than the actual price of the item, there will be a loss to store 160. In response to determining that there is a loss to store 160, system 110 determines whether a correction action is needed by personnel 150 of store 160. For determining whether the correction action is needed, system 110 determines whether the loss is greater than a predetermined number of standard deviations of a normal distribution of prices of an item, where the normal distribution is based on historical data of the prices of the item and the historical data is stored in the database. If the loss is greater than a predetermined number of standard deviations (e.g., one standard deviation), the correction action is needed; otherwise, no action is needed.

If the correction action is needed, system 110 notifies personnel 150 to correct the item mismatch before processing a transaction of the item. System 110 sends the notifications to personnel 150; for example, system 110 sends the notifications to a mobile device of personnel 150 through network 120. System 110 may also send the notifications to personnel 150 through checkout device 130. If the correction action is not needed, system 110 will process a transaction of the item at a price based on the scanned barcodes, the keyed-in numbers, or the customer chosen item name, and then system 110 notifies customer 140 that the transaction is a favorable deal to customer 140 (with a loss to store 160). For example, system 110 may send the notifications to customer 140 through checkout device 130 and/or indicate on a receipt the savings to customer 140.

If the price corresponding to the scanned barcode, the keyed-in number, or the customer chosen item name is greater than the actual price of the item, there will be a loss to customer 140. In response to determining that there is a loss to customer 140, system 110 notifies personnel 150 to correct the item mismatch and then process a transaction of the item at an actual price.

After processing transactions of items with mismatches, system 110 analyzes the mismatches. System 110 stores information of the mismatches in the database for future transactions of the same items. The database may be part of system 110; the database may also be a separate entity in system 100. The information stored in the database is used by system 110 to identify the mismatches and calculate the losses.

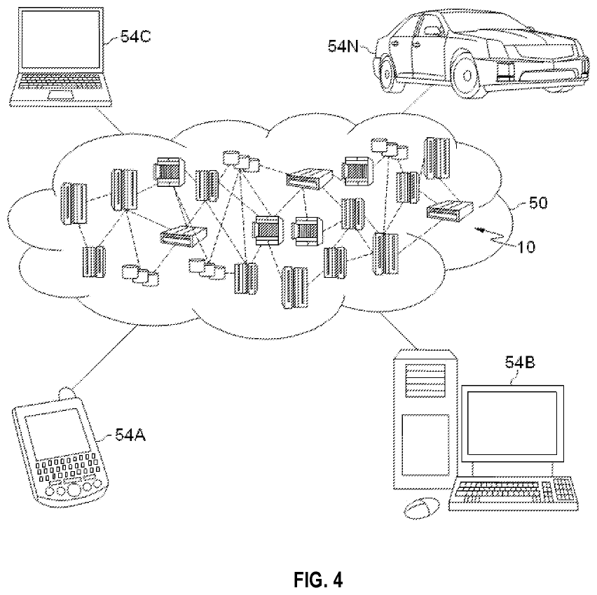

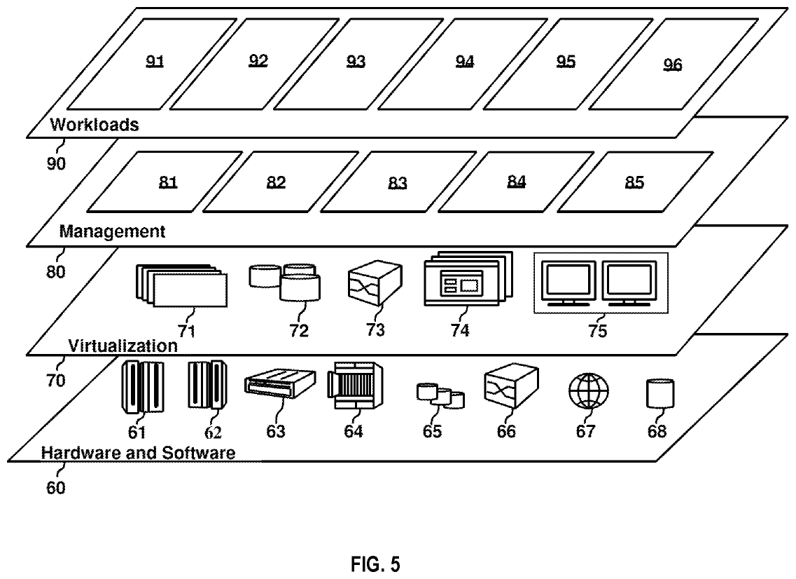

In another embodiment, system 110 may be implemented in a cloud computing environment. The cloud computing environment is described in more detail in later paragraphs with reference to FIG. 4 and FIG. 5. In yet another embodiment, system 110 may be situated on a computer device or server in store 160, which may be connected to another computer device or server in network 120 or in cloud. In yet another embodiment, system 110 may be embedded into checkout device 130.

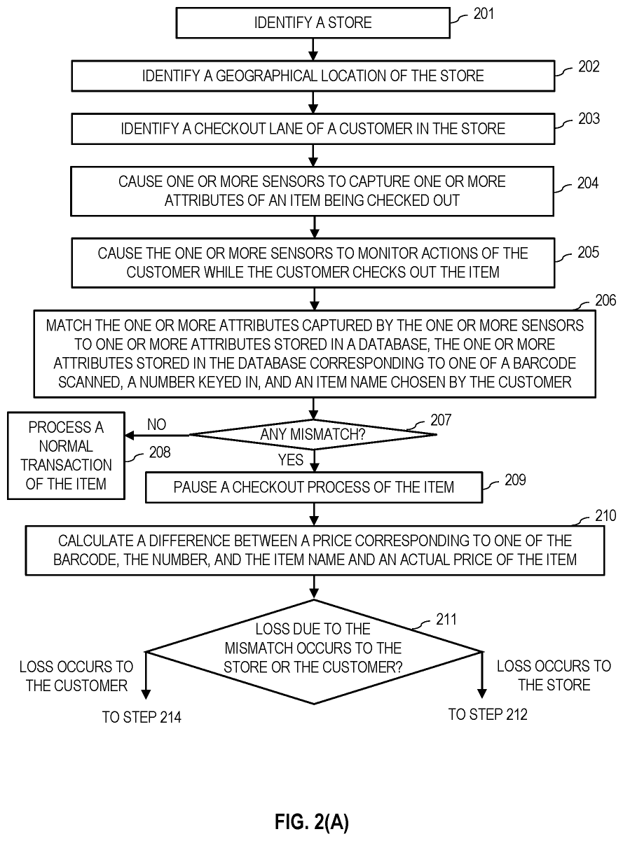

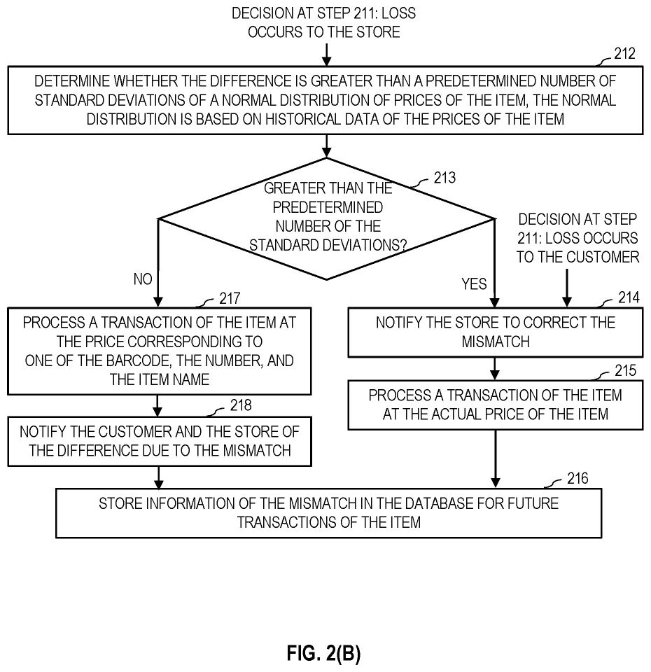

FIG. 2(A) and FIG. 2(B) present a flowchart showing operational steps of monitoring item mismatches during checkouts and preventing losses due to mismatches, in accordance with one embodiment of the present invention. In the example shown in FIG. 1, the operational steps are implemented by system 110 for analyzing data of checkouts, where system 110 is situated on a computing device or server.

Referring to FIG. 2(A), at step 201, the computing device or server identifies a store. The computing device or server analyzes the contextual environment where a customer is located, for example, a grocery store or a supermarket. At step 202, the computing device or server identifies a geographical location of the store. For example, the computing device or server is aware of the geographical location of the grocery store or the supermarket. At step 203, the computing device or server identifies a checkout lane of the customer in the store. Through the checkout lane (e.g., self-checkout lane), the customer checks out items purchased in the store. For example, the computing device or server is aware of the checkout lane when the customer approaches the checkout lane or scans a shopper card.

Further referring to FIG. 2(A), at step 204, the computing device or server causes one or more sensors to capture one or more attributes of an item being checked out. For example, a checkout device at checkout lane is equipped with the one or more sensors. For example, the one or more attributes may include but not limited to dimensions, weight, temperature, and texture. In another embodiment, the computing device or server causes one or more imaging devices to capture one or more images of an item being checked out.

At step 205, the computing device or server causes the one or more sensors to monitor actions of the customer while the customer checks out the item. Machine learning capabilities of the computing device or server identifies the shopper's actions; for example, the computing device or server identifies whether the customer is scanning the item or weighting the item.

Further referring to FIG. 2(A), at step 206, the computing device or server matches the one or more attributes captured by the one or more sensors to one or more attributes stored in a database, where the one or more attributes stored in the database is corresponding to one of a barcode scanned by the customer, a number keyed in by the customer, and an item name chosen by the customer. In another embodiment, the computing device or server matches the one or more images captured by the one or more imaging devices to one or more images stored in a database, where the one or more images stored in the database is corresponding to one of a barcode scanned by the customer, a number keyed in by the customer, and an item name chosen by the customer. The attributes or images for the expected barcode, number, or item name have been established within in the database. At step 206, the computing device or server identifies a situation in which the one or more attributes captured does not match the one or more attributes stored in the database or a situation in which the one or more images captured does not match the one or more images stored in the database; under this situation, a mismatch occurs. For example, in this situation of the mismatch, a wrong number is inputted or a wrong barcode is scanned for the item.

Further referring to FIG. 2(A), at step 207, the computing device or server determines whether any mismatch is identified. In response to determining that no mismatch is identified (NO branch of decision step 207), at step 208, the computing device or server processes a normal transaction of the item. In response to determining that the mismatch is identified (YES branch of decision step 207), at step 209, the computing device or server pauses a checkout process of the item. The computing device or server may prompt a warning message to the customer about the mismatch; for example, computing device or server may prompt a warning message about an entry error of the number.

Further referring to FIG. 2(A), at step 210, the computing device or server calculates a difference between a price corresponding to one of the barcode, the number, and the item name and an actual price of the item. The actual price of the item is a price corresponding to the one or more attributes captured by the one or more sensors. In another embodiment, the actual price of the item is a price corresponding to the image captured by the one or more imaging devices. System 110 retrieves from the database the price corresponding to one of the barcode, the number, and the item name and the actual price. If the price corresponding to one of the barcode, the number, and the item name is less than the actual price of the item, there will be a loss to the store; if the price corresponding to one of the barcode, the number, and the item name is greater than the actual price of the item, there will be a loss to the customer. At step 211, the computing device or server determines whether the loss due to the mismatch occurs to the store or to the customer. In response to determining that the loss due to the mismatch occurs to the store, the computing device or server will execute step 212 (shown in FIG. 2(B)). In response to determining that the loss due to the mismatch occurs to the customer, the computing device or server will execute step 214 (shown in FIG. 2(B)).

Now referring to FIG. 2(B), at step 212, the computing device or server determines whether the difference is greater than a predetermined number of standard deviations of a normal distribution of prices of the item, where the normal distribution is based on historical data of the prices of the item. For example, if the difference is within one standard deviation, the computing device or server will not consider the difference as a significant loss to the store; if the difference is greater than one standard deviation, the computing device or server will consider the difference as a significant loss to the store.

Referring to FIG. 2(B), in response to determining that the difference is greater than the predetermined number of standard deviations (YES branch of decision block 213), at step 214, the computing device or server notifies the store to correct the mismatch. Upon receiving the notification, personnel of the store corrects the mismatch. In response to the mismatch being corrected, at step 215, the computing device or server processes a transaction of the item at the actual price of the item. Therefore, the computing device or server prevents the store from the significant loss.

Referring to FIG. 2(B), in response to determining that the difference is not greater than the predetermined number of standard deviations (NO branch of decision block 213), at step 217, the computing device or server processes a transaction of the item at the price corresponding to one of the barcode, the number, and the item name. At step 218, the computing device or server notifies the customer and the store of the difference due to the mismatch. Under the situation where the difference is not greater than the predetermined number of standard deviations, the computing device or server decide to ignore the mismatch and focus on customer satisfaction by continuing the transaction process with the wrong price. For example, in this case, the receipt given to the customer may contain information indicating savings to the customer and thus the consumer knows that the consumer obtains an unexpectedly good deal.

Referring to FIG. 2(B), under the situation where the loss due to the mismatch occurs to the customer, the computing device or server executes steps 214 and 215. Steps 215 and 216 has been described in a previous paragraph in this document. The computing device or server processes a transaction of the item at the actual price of the item; therefore, the computing device or server prevents the customer from the loss.

Referring to FIG. 2(B), following either step 215 or step 218, at step 216, the computing device or server stores information of the mismatch in the database for future transactions of the item.

FIG. 3 is a diagram illustrating components of computing device or server 300, in accordance with one embodiment of the present invention. It should be appreciated that FIG. 3 provides only an illustration of one implementation and does not imply any limitations; different embodiments may be implemented.

Referring to FIG. 3, computing device or server 300 includes processor(s) 320, memory 310, and tangible storage device(s) 330. In FIG. 3, communications among the above-mentioned components of computing device or server 300 are denoted by numeral 390. Memory 310 includes ROM(s) (Read Only Memory) 311, RAM(s) (Random Access Memory) 313, and cache(s) 315. One or more operating systems 331 and one or more computer programs 333 reside on one or more computer readable tangible storage device(s) 330.

Computing device or server 300 further includes I/O interface(s) 350. I/O interface(s) 350 allows for input and output of data with external device(s) 360 that may be connected to computing device or server 300. Computing device or server 300 further includes network interface(s) 340 for communications between computing device or server 300 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of monitoring item mismatches during checkouts in stores and preventing losses due to the item mismatches.

1. A computer-implemented method for preventing losses due to item mismatches during checkouts in a store, the method comprising:
causing one or more sensors to capture one or more attributes of an item being checked out by a customer;
matching the one or more attributes captured by the one or more sensors to one or more attributes stored in a database, wherein the one or more attributes stored in the database is corresponding to one of a barcode scanned by the customer, a number keyed in by the customer, and an item name chosen by the customer;
in response to a mismatch, pausing a checkout process of the item;
calculating a difference between a price corresponding to one of the barcode, the number, and the item name and an actual price of the item;
determining whether the difference causes a loss occurring to the store or to the customer;
in response to determining the loss occurring to the store, determining whether the difference is greater than a predetermined number of standard deviations of a normal distribution of prices of the item, wherein the normal distribution is based on historical data of the prices of the item;
in response to determining the difference being greater than the predetermined number of standard deviations or in response to determining the loss occurring to the customer, notifying the store to correct the mismatch; and
in response to the mismatch being corrected, processing a transaction of the item at the actual price of the item.

2. The computer-implemented method of claim 1, further comprising:
in response to determining the difference being not greater than the predetermined number of standard deviations, processing a transaction of the item at the price corresponding to one of the barcode, the number, and the item name; and
notifying the customer of savings to the customer.

3. (canceled)

4. The computer-implemented method of claim 1, further comprising:
storing information of the mismatch in the database for future transactions of the item.

5. The computer-implemented method of claim 1, further comprising:
in response to no mismatch, processing a normal transaction of the item.

6. The computer-implemented method of claim 1, further comprising:
identifying the store;
identifying a geographical location of the store; and
identifying a checkout lane of the customer in the store.

7. The computer-implemented method of claim 1, further comprising:
causing the one or more sensors to monitor actions of the customer while the customer checks out the item.

8. A computer program product for preventing losses due to item mismatches during checkouts in a store, the computer program product comprising a computer readable storage medium having program instructions embodied therewith, the program instructions executable by one or more processors, the program instructions executable to:
cause one or more sensors to capture one or more attributes of an item being checked out by a customer;
match the one or more attributes captured by the one or more sensors to one or more attributes stored in a database, wherein the one or more attributes stored in the database is corresponding to one of a barcode scanned by the customer, a number keyed in by the customer, and an item name chosen by the customer;
in response to a mismatch, pause a checkout process of the item;
calculate a difference between a price corresponding to one of the barcode, the number, and the item name and an actual price of the item;
determine whether the difference causes a loss occurring to the store or to the customer;
in response to determining the loss occurring to the store, determine whether the difference is greater than a predetermined number of standard deviations of a normal distribution of prices of the item, wherein the normal distribution is based on historical data of the prices of the item;
in response to determining the difference being greater than the predetermined number of standard deviations or in response to determining the loss occurring to the customer, notify the store to correct the mismatch; and
in response to the mismatch being corrected, process a transaction of the item at the actual price of the item.

9. The computer program product of claim 8, further comprising the program instructions executable to:
in response to determining the difference being not greater than the predetermined number of standard deviations, process a transaction of the item at the price corresponding to one of the barcode, the number, and the item name; and
notify the customer of savings to the customer.

10. (canceled)

11. The computer program product of claim 8, further comprising the program instructions executable to:
store information of the mismatch in the database for future transactions of the item.

12. The computer program product of claim 8, further comprising the program instructions executable to:
in response to no mismatch, process a normal transaction of the item.

13. The computer program product of claim 8, further comprising program instructions executable to:
identify the store;
identify a geographical location of the store; and
identify a checkout lane of the customer in the store.

14. The computer program product of claim 8, further comprising the program instructions executable to:
cause the one or more sensors to monitor actions of the customer while the customer checks out the item.

15. A computer system for preventing losses due to item mismatches during checkouts in a store, the computer system comprising:
one or more processors, one or more computer readable tangible storage devices, and program instructions stored on at least one of the one or more computer readable tangible storage devices for execution by at least one of the one or more processors, the program instructions executable to:
cause one or more sensors to capture one or more attributes of an item being checked out by a customer;
match the one or more attributes captured by the one or more sensors to one or more attributes stored in a database, wherein the one or more attributes stored in the database is corresponding to one of a barcode scanned by the customer, a number keyed in by the customer, and an item name chosen by the customer;
in response to a mismatch, pause a checkout process of the item;
calculate a difference between a price corresponding to one of the barcode, the number, and the item name and an actual price of the item;
determine whether the difference causes a loss occurring to the store or to the customer;
in response to determining the loss occurring to the store, determine whether the difference is greater than a predetermined number of standard deviations of a normal distribution of prices of the item, wherein the normal distribution is based on historical data of the prices of the item;
in response to determining the difference being greater than the predetermined number of standard deviations or in response to determining the loss occurring to the customer, notify the store to correct the mismatch; and
in response to the mismatch being corrected, process a transaction of the item at the actual price of the item.

16. The computer system of claim 15, further comprising the program instructions executable to:
in response to determining the difference being not greater than the predetermined number of standard deviations, process a transaction of the item at the price corresponding to one of the barcode, the number, and the item name; and
notify the customer of savings to the customer.

17. (canceled)

18. The computer system of claim 15, further comprising the program instructions executable to:
store information of the mismatch in the database for future transactions of the item.

19. The computer system of claim 15, further comprising the program instructions executable to:
in response to no mismatch, process a normal transaction of the item.

20. The computer system of claim 15, further comprising program instructions executable to:
cause the one or more sensors to monitor actions of the customer while the customer checks out the item.
